(19) United States
(12) Patent Application Publication
(10) Pub. No.: US 2026/0186890 A1
(43) Pub. Date: Jul. 2, 2026

(54) LOG CORRELATION

(71) Applicant: INTERNATIONAL BUSINESS MACHINES CORPORATION, Armonk, NY (US)

(72) Inventors: Mayank Sharma, BANGALORE (IN); Vinay Nair, Hyderabad (IN); Hareesh Payyadakkath, BANGALORE (IN); ADITI BHATTACHARYA, Kolkata (IN); SANDEEP DIXIT, Bangalore (IN)

(21) Appl. No.: 19/007,766

(22) Filed: Jan. 2, 2025

(51) Int. Cl. G06F 11/07; G06F 8/75; G06F 11/34; G06F 11/3604; G06F 40/205

(52) U.S. Cl. CPC G06F 11/0793; G06F 8/75; G06F 11/3476; G06F 11/3612; G06F 40/205

(57) ABSTRACT

Methods and systems include converting an event log for an application into event log process information. The source code for the application is converted into source code process information. Relations between the event log process information, the source code process information, and an initial process model that is implemented by the application are identified using fuzzy logic on a set of events. A unified process model is generated using the relations. A problem in execution of the application is resolved based on the unified process model.

### BACKGROUND

The present invention generally relates to system maintenance and, more particularly, to correlation of process information from multiple sources.

Modern systems may include a complex interrelationship between different components, created to achieve an intended purpose. The functioning of these systems may be defined at multiple levels of abstraction, with a relatively high-level process describing the steps that the system is to take to achieve its purpose, and with relatively low-level source code describing the technical operations that are performed to implement those steps.

When an incident occurs that frustrates the purpose of the system, it can be difficult to identify and address the cause of the incident.

### SUMMARY

A method for system incident resolution includes converting an event log for an application into event log process information. The source code for the application is converted into source code process information. Relations between the event log process information, the source code process information, and an initial process model that is implemented by the application are identified using fuzzy logic on a set of events. A unified process model is generated using the relations. A problem in execution of the application is resolved based on the unified process model.

A computer program product includes one or more computer-readable storage media and program instructions stored on the one or more computer-readable storage media to perform operations. The operations include converting an event log for an application into event log process information, converting source code for the application into source code process information, identifying relations between the event log process information, the source code process information, and an initial process model that is implemented by the application using fuzzy logic on a set of events, generating a unified process model using the relations, and resolving a problem in execution of the application based on the unified process model.

A computer system includes a processor set, one or more computer-readable storage media, and program instructions stored on the one or more computer-readable storage media to cause the processor set to perform operations. The operations include converting an event log for an application into event log process information, converting source code for the application into source code process information, identifying relations between the event log process information, the source code process information, and an initial process model that is implemented by the application using fuzzy logic on a set of events, generating a unified process model using the relations, and resolving a problem in execution.

These and other features and advantages will become apparent from the following detailed description of illustrative embodiments thereof, which is to be read in connection with the accompanying drawings.

### BRIEF DESCRIPTION OF THE DRAWINGS

The following description will provide details of preferred embodiments with reference to the following figures wherein:

FIG. 1 is a block diagram of multi-source process model determination, in accordance with an embodiment of the present invention;

FIG. 2 is a block/flow diagram of a method for identifying relations between different types of process information, in accordance with an embodiment of the present invention;

FIG. 3 is a block/flow diagram of a method for resolving an incident using a unified process model, in accordance with an embodiment of the present invention; and

FIG. 4 is a block diagram of a computing environment that can perform multi-source process model determination.

### DETAILED DESCRIPTION

Multiple sources of information can be combined to generate a detailed process model for a complex system. For example, the relatively high-level process information may be combined with process information that is generated from low-level sources, including a log of events for a software application as well as source code for the software application. The process information from these different sources can be fused to generate a detailed process model which combines a high-level definition of the steps being taken with a low-level understanding of how the system is actually performing those steps. When an incident occurs, this detailed process model may be used to guide a response. When addressing a set of incidents, the automated decision making system may prioritize individual incidents based on the impact they have and their urgency, where impact may be measured as an extent of potential damage that the incident may cause and urgency may be measured as a deadline on resolution of the incident.

Process information may be derived from run-time data analysis to collect process modelling information. Static code analysis can be used to derive information about the operation of technological systems. Process modelling can be based on these information sources to document workflows and key metrics and to automate a process. This may include process mapping, which identifies correspondences between process elements and application components, for example documenting entry and exit criteria with expected return code, as well as dependencies. To this end, a machine learning system such as a large language model may be used to combine process model information and technical information.

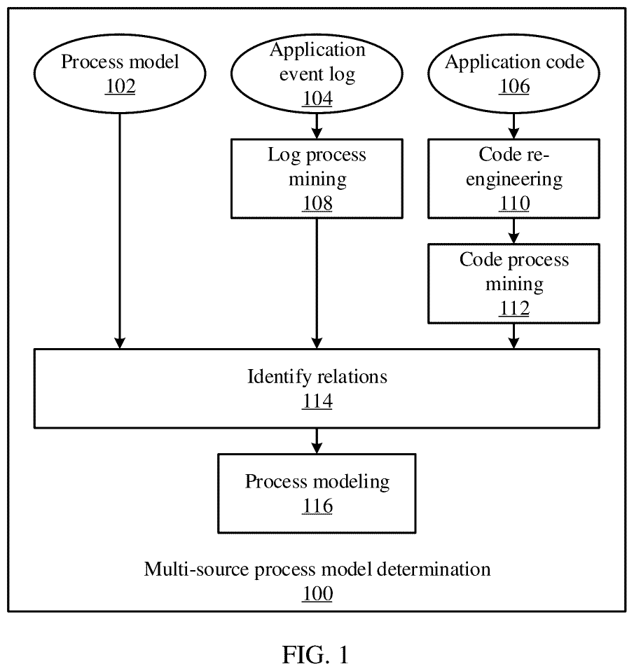

Referring now to FIG. 1, a process for multi-source process model determination 100 is shown. Block 102 represents a process model, which may already be expressed in a process model and notation formal, identifying a workflow for the process with defined steps and decisions. The process model may be generated by any appropriate method, such as by subject matter experts or by automatic process mining.

Log process mining 108 may be performed on an application event log 104. The application event log 104 includes outputs generated by an application used in executing the process, for example detailing actions that the application takes with appropriate notations for inputs and outputs. The application event log 104 may be generated automatically by an application or may be created by aftermarket instrumentation or other monitoring. The log process mining 108 generates an output which may be in a same format as the process model 102. In some cases, the application event log 104 may further include system logs that are generated by the operating system and other applications running on the same system as the application. The application event log 104 may be generated within a mainframe environment, a cloud system, or any other appropriate computing environment.

Application code 106 undergoes code re-engineering 110 to convert it into a form that can be used for code process mining 112. The application code 106 is analyzed to identify process information that may not be evident from the application event log 104. The output of the code process mining 112 may be in the same format as the process model 102. The code re-engineering 110 seeks to identify events within the application code, such as system calls, that can be represented as parts of a process model. Comments within the code can furthermore be parsed to identify descriptions of the components code. These events are then reframed in the format of the process model to match the other sequences. This process may further include review of application components to better identify sequences.

The process information derived from the process model 102, the application event log 104, and the application code 106 are provided to a generative machine learning system to identify relations 114 between them. The machine learning system may perform a variety of functions, including data augmentation, anomaly detection, pattern recognition, and data synthesis, to accomplish this. The output of the machine learning system may be a unified sequence that fuses the sequences from the different data sources. For example, a high-level event from the process model 102 may be associated with a number of events from the application event log 104 and further with particular functions and system calls in the application code 106. The output of block 114 may thus be an expanded sequence that includes a combination all of the elements from the different sources, with relationships between them identified. Based on the output of the machine learning system, block 116 performs process modeling to generate a new process model that captures the process information from the different sources.

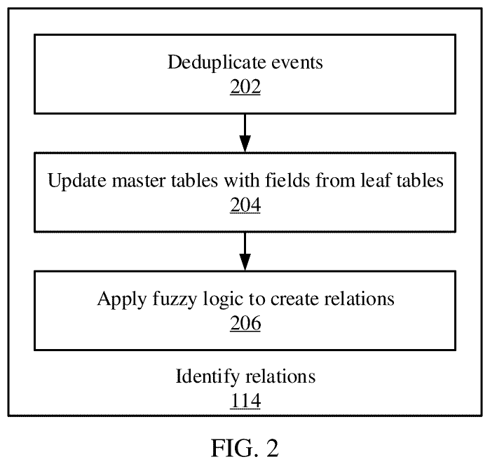

Referring now to FIG. 2, additional detail on the identification of relations 114 is shown. Information from the application source code 106 and the application event log 104 may be stored in a first database table and information about the process model 102 may be stored in a second database table. Block 202 deduplicates the event process based on event number. The following database commands represent an exemplary deduplication:
INSERT INTO “EVENT_MASTER” (“EVENT_NUMBER”)
SELECT DISTINCT “EVENT_NUMBER” FROM “BPData” WHERE “IN_ROLLUP”=0 and “EVENT_NUMBER” IS NOT NULL EXCEPT
SELECT “EVENT_NUMBER” FROM “EVENT_MASTER”;

Block 204 updates a master database table and the second database table with data fields from the first database table and the second database table. Block 206 uses fuzzy logic to create relations between the process model 102 and the application source code 106 and application event log 104. The following commands represent exemplary fuzzy logic:
SELECT IT.ProgramName, ‘Purchase’ as Process
FROM FirstDatabase as IT, SecondDatabase as PM
WHERE
(UPPER(PM.Description) like ‘%PURCHASE%’ AND UPPER(IT.Comment) like ‘%PURCHASE%’) OR
(UPPER(PM.Description) like ‘%QUOTATION%’ AND UPPER(IT.Comment) like ‘% QUOTATION%’) OR
(UPPER(PM.Description) like ‘% QUOTE%SUPPLIER%’ AND UPPER(IT.Comment) like ‘%QUOTE%SUPPLIER%’) OR
(UPPER(PM.Description) like ‘%SETTLE%SUPPLIER%’ AND UPPER(IT.Comment) like ‘%SETTLE%SUPPLIER%’ ) OR
(UPPER(PM.Description) like ‘%DELIVER%GOOD%’ AND UPPER(IT.Comment) like ‘% DELIVER%GOOD %’) OR
(UPPER(PM.Description) like ‘%PURCHAGE%PAYMENT%’ AND UPPER(IT.Comment) like ‘% PURCHAGE%PAYMENT %’) OR
(UPPER(PM.Description) like ‘%DELIVER%GOOD%’ AND UPPER(IT.Comment) like ‘%PURCHASE%’) OR
(UPPER(PM.Description) like ‘%DELIVER%GOOD%’ AND UPPER(IT.Comment) like ‘%PURCHASE%’)
Fuzzy Logic is a mathematical framework designed to handle uncertainty and imprecision in decision-making. Unlike traditional binary logic, where variables are strictly true or false (0 or 1), fuzzy logic allows for degrees of truth. For example, instead of categorizing an incident as either “Application Specific” or “Infrastructure Specific,” fuzzy logic may assign a value that represents degrees to which the incident is associated with both. This approach is particularly useful for modeling real-world scenarios where information is often vague or incomplete. Events may be captured through various types of messages in the various types of logs. The combination of these related messages helps to define an appropriate category.

The flexibility of fuzzy logic allows it to work effectively in situations where precise mathematical formulations are difficult or impossible. For example, incidents that occur in a complex system may need natural language processing to identify patterns. By using fuzzy rules, such as, “If the incident is infrastructure-related, then focus on knowledge articles for different Infra queues and identify the appropriate runbook to resolve it,” fuzzy logic simplifies the design of control systems and helps isolate issues that are not clearly defined as binary 0 or 1.

This approach can be helpful in areas with nonlinear relationships or incomplete data. For example, fuzzy logic can be used to diagnose performance issues in hybrid applications running in complex environments, reducing ambiguity by connecting missing dots. Fuzzy logic is also increasingly employed in hybrid AI systems, combining its strength in handling ambiguity with the precision of machine learning models.

As noted above, block 204 updates a master table. The master table serves as a source of truth and stores standardized, processed data for use in decision-making. Block 204 refines incoming data before storing it in the master table. In particular, each source of log data may have its own unique format, so leaf tables are used as the initial layer of data processing, including the first database table and the second database table. These leaf tables act as flexible, unrestricted repositories that accept data in its raw form. The leaf tables serve as a source of truth for raw data. The data is then transformed, for example by deduplication, discard of errors, refinement, and standardization, before it is added to the master table.

For example, the first database table may be tailored to capture and organize dynamic process event logs, while the second database table may be structured to handle static event logs, such as system logs or console logs. Preparing the raw data may include several steps.

First, data may be collected from the various sources and may be imported in appropriate formats to load into the leaf tables. Data cleaning then ensures accuracy by handling missing values, correcting errors, removing duplicates, and standardizing formats for dates and other common data types. Preprocessing then normalizes, encodes, and parses the data to extract meaningful information.

The data may be transformed by, e.g., aggregating, pivoting, and engineering new features. Integration combines data from multiple sources, reconciles inconsistencies, and establishes relationships. Validation ensures data integrity, checks consistency, and resolves anomalies. Sampling selects a subset for testing or analysis using methods like random or stratified sampling. Exploratory data analysis provides insights through statistics, visualizations, and outlier detection. Irrelevant data is reduced, and dimensionality is minimized where needed. Anonymization protects sensitive information by masking or removing personal details. Data formatting organizes data into usable structures and converts types as necessary. Enrichment adds context with external data or derived metrics, while annotation labels data for tasks like machine learning. Finally, the prepared data is rolled up into the master tables for future reference.

Fuzzy logic helps to down the problem's search area and to categorize it effectively. Once the problem area is identified, the fuzzy logic facilitates the generation of auto-prompts, which leverage generative machine learning to craft tailored solutions. These intelligent prompts guide the generative machine learning model to produce accurate and context-specific resolutions, streamlining the problem-solving process. For example, fuzzy logic can be used to generate targeted prompts to create solutions for issues like system errors, performance anomalies, or configuration mismatches.

For example, if the problem category is infrastructure, then the prompt may refer to a infrastructural sample fix template and create an infrastructure-related solution template. If the problem category is application, then the prompt may refer to the an application sample fix template and create an application related solution template. The generated template will be applied to the system to run and fix the issue.

The relations that are created by the fuzzy logic 206 establish, for example, that particular events and source code instructions are connected to particular steps in a given process. The relations can therefore be used to identify the particular instructions that are most closely associated with a given event within the process. If an incident occurs, such as the failure of a particular step of the high-level process model, a fault within the application or the execution environment can be diagnosed. In one example, a given step may ultimately fail due to a lack of storage space. This fault may be identified by identifying events from the application event log 104 and source code 106 that implement the step so that the events can be inspected and it can be determined what the application was attempting to do when the fault occurred.

The mining process streamlines issue management by leveraging a weight assignment-based learning-based algorithm for continuous refinement of relationships between problem categories and solutions. Initially, the fuzzy logic algorithm assigns weights to potential relationships based on historical data, frequency, and contextual relevance. As new tickets are logged, these weights are dynamically adjusted, reflecting evolving patterns and priorities. Feedback loops, including user input, subject matter expert inputs, and anomaly detection further refine the accuracy of these relationships, ensuring that the system prioritizes the most relevant solutions and associated template. Over time, optimized weight assignments may be found that enhance the efficiency and precision of ticket categorization and resolution. This adaptive process enables quicker issue identification, smarter solution generation, and overall improved operational efficiency. The problem-solution relationship may not be clear initially, but during subsequent iterations, the system will refine it based on past learning, resulting in quicker and more accurate relationships.

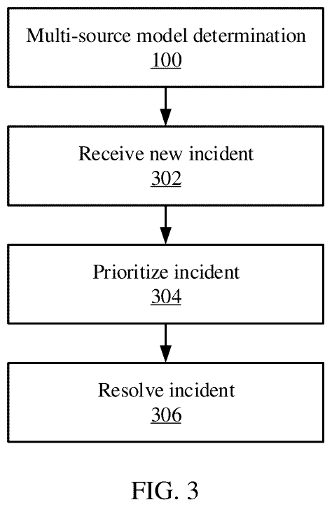

Referring now to FIG. 3, a method for detecting and resolving an incident is shown. As described above, block 100 performs multi-source model determination to create a fused process model from multiple process information sources. A new incident is received at block 302, where the incident may be detected by any appropriate process. For example, time-series analysis of information generated by sensors within a complex system may be used to detect anomalous states and/or operation. In some cases the incident may be reported by a user or subject matter expert.

In some cases the incident be explicitly related to a step in the process model 102. In other cases the incident may be identified based on information from the application event log 104, without explicit reference to the process model 102. Block 304 determines a priority for the incident, for example relating to an importance and urgency of an associated step in the process model 102. Parts of the process model 102 may have a relatively high or low importance based on the impact they have on the outcome of the process model 102 and/or the impact they have on the outcome of other applications or instances of the same application. For example, running out of storage space may implicate all processes running on the system, leading to a relatively high priority.

Block 306 resolves the incident, for example by automatically issuing commands to the application or to the computing environment. Following the example of running out of storage space, block 306 may act to free storage space by, e.g., deleting temporary files. Block 306 may furthermore interact with the application itself, for example instructing the application to use storage space more efficiently or otherwise changing the configuration or parameters of the application. Thus resolving the action 306 may include starting or stopping a process, changing a configuration setting of the application, or by changing a property of the computing environment (e.g., freeing storage).

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 400 contains an example of an environment for the execution of at least some of the computer code involved in performing the inventive methods, such as multi-source process model determination 419. In addition to block 419, computing environment 400 includes, for example, computer 401, wide area network (WAN) 402, end user device (EUD) 403, remote server 404, public cloud 405, and private cloud 406. In this embodiment, computer 401 includes processor set 410 (including processing circuitry 420 and cache 421), communication fabric 411, volatile memory 412, persistent storage 413 (including operating system 422 and block 419, as identified above), peripheral device set 414 (including user interface (UI) device set 423, storage 424, and Internet of Things (IoT) sensor set 425), and network module 415. Remote server 404 includes remote database 430. Public cloud 405 includes gateway 440, cloud orchestration module 441, host physical machine set 442, virtual machine set 443, and container set 444.

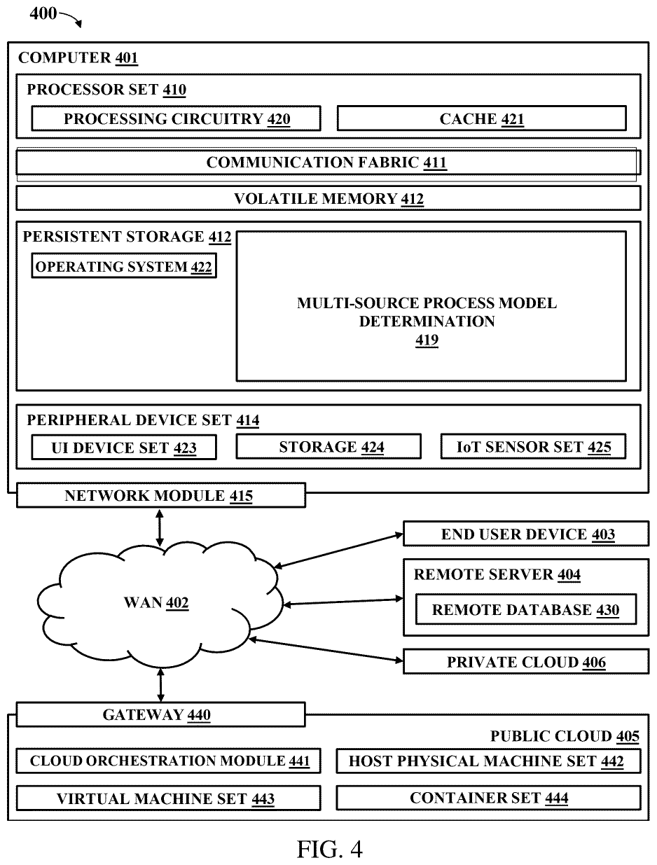

COMPUTER 401 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 430. As is well understood in the art of computer technology, and depending upon the technology, performance of a computer-implemented method may be distributed among multiple computers and/or between multiple locations. On the other hand, in this presentation of computing environment 400, detailed discussion is focused on a single computer, specifically computer 401, to keep the presentation as simple as possible. Computer 401 may be located in a cloud, even though it is not shown in a cloud in FIG. 4. On the other hand, computer 401 is not required to be in a cloud except to any extent as may be affirmatively indicated.

PROCESSOR SET 410 includes one, or more, computer processors of any type now known or to be developed in the future. Processing circuitry 420 may be distributed over multiple packages, for example, multiple, coordinated integrated circuit chips. Processing circuitry 420 may implement multiple processor threads and/or multiple processor cores. Cache 421 is memory that is located in the processor chip package(s) and is typically used for data or code that should be available for rapid access by the threads or cores running on processor set 410. Cache memories are typically organized into multiple levels depending upon relative proximity to the processing circuitry. Alternatively, some, or all, of the cache for the processor set may be located “off chip.” In some computing environments, processor set 410 may be designed for working with qubits and performing quantum computing.

Computer readable program instructions are typically loaded onto computer 401 to cause a series of operational steps to be performed by processor set 410 of computer 401 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 421 and the other storage media discussed below. The program instructions, and associated data, are accessed by processor set 410 to control and direct performance of the inventive methods. In computing environment 400, at least some of the instructions for performing the inventive methods may be stored in block 419 in persistent storage 413.

COMMUNICATION FABRIC 411 is the signal conduction path that allows the various components of computer 401 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 412 is any type of volatile memory now known or to be developed in the future. Examples include dynamic type random access memory (RAM) or static type RAM. Typically, volatile memory 412 is characterized by random access, but this is not required unless affirmatively indicated. In computer 401, the volatile memory 412 is located in a single package and is internal to computer 401, but, alternatively or additionally, the volatile memory may be distributed over multiple packages and/or located externally with respect to computer 401.

PERSISTENT STORAGE 413 is any form of non-volatile storage for computers that is now known or to be developed in the future. The non-volatility of this storage means that the stored data is maintained regardless of whether power is being supplied to computer 401 and/or directly to persistent storage 413. Persistent storage 413 may be a read only memory (ROM), but typically at least a portion of the persistent storage allows writing of data, deletion of data and re-writing of data. Some familiar forms of persistent storage include magnetic disks and solid state storage devices. Operating system 422 may take several forms, such as various known proprietary operating systems or open source Portable Operating System Interface-type operating systems that employ a kernel. The code included in block 419 typically includes at least some of the computer code involved in performing the inventive methods.

PERIPHERAL DEVICE SET 414 includes the set of peripheral devices of computer 401. Data communication connections between the peripheral devices and the other components of computer 401 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 423 may include components such as a display screen, speaker, microphone, wearable devices (such as goggles and smart watches), keyboard, mouse, printer, touchpad, game controllers, and haptic devices. Storage 424 is external storage, such as an external hard drive, or insertable storage, such as an SD card. Storage 424 may be persistent and/or volatile. In some embodiments, storage 424 may take the form of a quantum computing storage device for storing data in the form of qubits. In embodiments where computer 401 is required to have a large amount of storage (for example, where computer 401 locally stores and manages a large database) then this storage may be provided by peripheral storage devices designed for storing very large amounts of data, such as a storage area network (SAN) that is shared by multiple, geographically distributed computers. IoT sensor set 425 is made up of sensors that can be used in Internet of Things applications. For example, one sensor may be a thermometer and another sensor may be a motion detector.

NETWORK MODULE 415 is the collection of computer software, hardware, and firmware that allows computer 401 to communicate with other computers through WAN 402. Network module 415 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 415 are performed on the same physical hardware device. In other embodiments (for example, embodiments that utilize software-defined networking (SDN)), the control functions and the forwarding functions of network module 415 are performed on physically separate devices, such that the control functions manage several different network hardware devices. Computer readable program instructions for performing the inventive methods can typically be downloaded to computer 401 from an external computer or external storage device through a network adapter card or network interface included in network module 415. WAN 402 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 403 is any computer system that is used and controlled by an end user (for example, a customer of an enterprise that operates computer 401), and may take any of the forms discussed above in connection with computer 401. EUD 403 typically receives helpful and useful data from the operations of computer 401. For example, in a hypothetical case where computer 401 is designed to provide a recommendation to an end user, this recommendation would typically be communicated from network module 415 of computer 401 through WAN 402 to EUD 403. In this way, EUD 403 can display, or otherwise present, the recommendation to an end user. In some embodiments, EUD 403 may be a client device, such as thin client, heavy client, mainframe computer, desktop computer and so on.

REMOTE SERVER 404 is any computer system that serves at least some data and/or functionality to computer 401. Remote server 404 may be controlled and used by the same entity that operates computer 401. Remote server 404 represents the machine(s) that collect and store helpful and useful data for use by other computers, such as computer 401. For example, in a hypothetical case where computer 401 is designed and programmed to provide a recommendation based on historical data, then this historical data may be provided to computer 401 from remote database 430 of remote server 404.

PUBLIC CLOUD 405 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 405 is performed by the computer hardware and/or software of cloud orchestration module 441. The computing resources provided by public cloud 405 are typically implemented by virtual computing environments that run on various computers making up the computers of host physical machine set 442, which is the universe of physical computers in and/or available to public cloud 405. The virtual computing environments (VCEs) typically take the form of virtual machines from virtual machine set 443 and/or containers from container set 444. It is understood that these VCEs may be stored as images and may be transferred among and between the various physical machine hosts, either as images or after instantiation of the VCE. Cloud orchestration module 441 manages the transfer and storage of images, deploys new instantiations of VCEs and manages active instantiations of VCE deployments. Gateway 440 is the collection of computer software, hardware, and firmware that allows public cloud 405 to communicate through WAN 402. Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 406 is similar to public cloud 405, except that the computing resources are only available for use by a single enterprise. While private cloud 406 is depicted as being in communication with WAN 402, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 405 and private cloud 406 are both part of a larger hybrid cloud.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Having described preferred embodiments of log correlation (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

1. A computer-implemented method for system incident resolution, comprising:
converting an event log for an application into event log process information;
converting source code for the application into source code process information;
identifying relations between the event log process information, the source code process information, and an initial process model that is implemented by the application using fuzzy logic on a set of events;
generating a unified process model using the relations; and
resolving a problem in execution of the application based on the unified process model.

2. The method of claim 1, wherein converting the source code includes parsing comments in the source code.

3. The method of claim 2, wherein the relations include a correspondence between a high-level step of the initial process model and a function of the source code.

4. The method of claim 2, wherein the relations include a correspondence between a high-level step of the initial process model and an event of the event log.

5. The method of claim 1, wherein identifying the relations uses fuzzy logic to identify one or more categories that include infrastructure-specific and application-specific categories.

6. The method of claim 1, wherein identifying relations includes deduplicating events in the event log process information and the source code process information.

7. The method of claim 1, wherein resolving the problem includes performing an automatic action in accordance with the unified process model.

8. The method of claim 7, wherein the automatic action includes one or more of starting or stopping a process, changing a configuration setting of the application, or changing a property of a computing environment.

9. The method of claim 1, wherein resolving the problem includes prioritizing the problem using an importance and urgency of an associated step in the unified process model.

10. The method of claim 1, wherein the relations identify elements of the source code that implement elements of the initial process model.

11. A computer program product, comprising:
one or more computer-readable storage media; and
program instructions stored on the one or more computer-readable storage media to perform operations comprising:
converting an event log for an application into event log process information;
converting source code for the application into source code process information;
identifying relations between the event log process information, the source code process information, and an initial process model that is implemented by the application using fuzzy logic on a set of events;
generating a unified process model using the relations; and
resolving a problem in execution of the application based on the unified process model.

12. A computer system, comprising:
a processor set;
one or more computer-readable storage media; and
program instructions stored on the one or more computer-readable storage media to cause the processor set to perform operations comprising:
converting an event log for an application into event log process information;
converting source code for the application into source code process information;
identifying relations between the event log process information, the source code process information, and an initial process model that is implemented by the application using fuzzy logic on a set of events;
generating a unified process model using the relations; and
resolving a problem in execution of the application based on the unified process model.

13. The system of claim 12, wherein converting the source code includes parsing comments in the source code.

14. The system of claim 13, wherein the relations include a correspondence between a high-level step of the initial process model and a function of the source code.

15. The system of claim 13, wherein the relations include a correspondence between a high-level step of the initial process model and an event of the event log.

16. The system of claim 12, wherein identifying the relations uses fuzzy logic to identify one or more categories that include infrastructure-specific and application-specific categories.

17. The system of claim 12, wherein identifying relations includes deduplicating events in the event log process information and the source code process information.

18. The system of claim 12, wherein resolving the problem includes performing an automatic action in accordance with the unified process model.

19. The system of claim 18, wherein the automatic action includes one or more of starting or stopping a process, changing a configuration setting of the application, or changing a property of a computing environment.

20. The system of claim 12, wherein the relations identify elements of the source code that implement elements of the initial process model.
